(19) United States
(12) Patent Application Publication
(10) Pub. No.: US 2007/0062211 A1
(43) Pub. Date: Mar. 22, 2007

(54) Coil cleaner and method of operating a coil cleaner

(76) Inventors: Viktor J. Anderson, Muskegon, MI (US); Matthew R. Baker, Holland, MI (US); Benjamin J. DeJager, Grand Rapids, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 11/233,285

(22) Filed: Sep. 22, 2005

(51) Int. Cl. F28G 1/12; A23L 3/36

(52) U.S. Cl. 62/303; 165/95

(57) ABSTRACT

A coil cleaner for a condenser coil of a refrigeration system includes a sweeper assembly. The sweeper assembly has a pair of parallel brushes. Two motors, one located on either side of the sweeper assembly, are coupled to a first and second screw. The sweeper assembly is connected to the first and second screw by way of two nuts. The nuts travel on their respective screws when the screws are rotated, thus moving the sweeper assembly across the condenser coil. A controller manages the operation of the sweeper assembly. When the sweeper assembly has moved a predetermined distance, the sweeper assembly contacts a pair of sensors independently controlling each of the two motors. After contact with the sensors, the motors are reversed, and the sweeper assembly moves in the opposite direction. When the sweeper assembly contacts a second pair of sensors, both motors are turned off.

A condenser coil is one of the most important elements of any refrigerated system. Due to the air flow over the condenser coil, debris and dust settle on the condenser coil. If the condenser coil is not cleaned, the efficiency of the cooling system is reduced. Therefore, condenser coils should be regularly cleaned.

Cleaning of condenser coils is problematic. Condenser coils are generally concealed from view, and thus regular maintenance is often forgotten. Further, since condenser coils are cleaned infrequently, the dust and debris built up on a condenser coil can be difficult to remove.

Various chemicals have been developed to clean condenser coils. However, these chemicals are difficult to use.

Further, a business may have multiple refrigerated displays at a variety of locations. Thus, cleaning of the condenser coil for each of several refrigerated displays is time consuming and costly.

An improved device and method for cleaning condenser coils is thus highly desirable.

### SUMMARY OF THE INVENTION

A coil cleaner includes an actuator assembly for moving a sweeper across the condenser coil. The actuator assembly includes a motor to turn a screw shaft. The screw shaft is attached to the sweeper by a nut riding on the shaft. As the screw shaft turns, the sweeper is raised or lowered.

The actuator assembly includes a pair of sensors. A sensor is placed proximal to each first end of the screw shaft. When the sweeper has moved the desired distance across the condenser coil, it activates one sensor. The signal from the sensor is used to stop the motor and then reverse the direction of the motor. The sweeper then travels in the opposite direction until it activates the second sensor. The motor is then turned off.

A second actuator assembly could be also be used. The second actuator system has a second motor engaging a screw shaft. A sensor is placed near the end of each screw shaft.

A controller may be used to control the motors and sensors. The controller would energize the motors at predetermined times to clean the condenser coil. The controller would cause the motors to move the sweeper in one direction. When the sweeper activates the sensor, the motor corresponding to that sensor would be turned off. After both motors are turned off, the controller reverses the motion of the motors and thus the sweeper to move in the opposite direction. When two additional sensors are closed, the motors are turned off and the controller waits a predetermined time before cleaning the condenser coil again.

These and other objects, advantages and features of the invention will be more readily understood and appreciated by reference to the detailed description of the drawings.

### BRIEF DESCRIPTION OF THE DRAWINGS

FIG. 1 shows a coil cleaner for use with condenser coil.

FIG. 2 shows a coil cleaner.

FIG. 3 is an exploded view of the coil cleaner.

FIG. 4 is an exploded view of a drive assembly for a coil cleaner.

FIG. 5 is a block diagram for the control system for a coil cleaner.

FIG. 6 is a flow chart showing the operation of the control system for a coil cleaner.

### DETAILED DESCRIPTION OF THE DRAWINGS

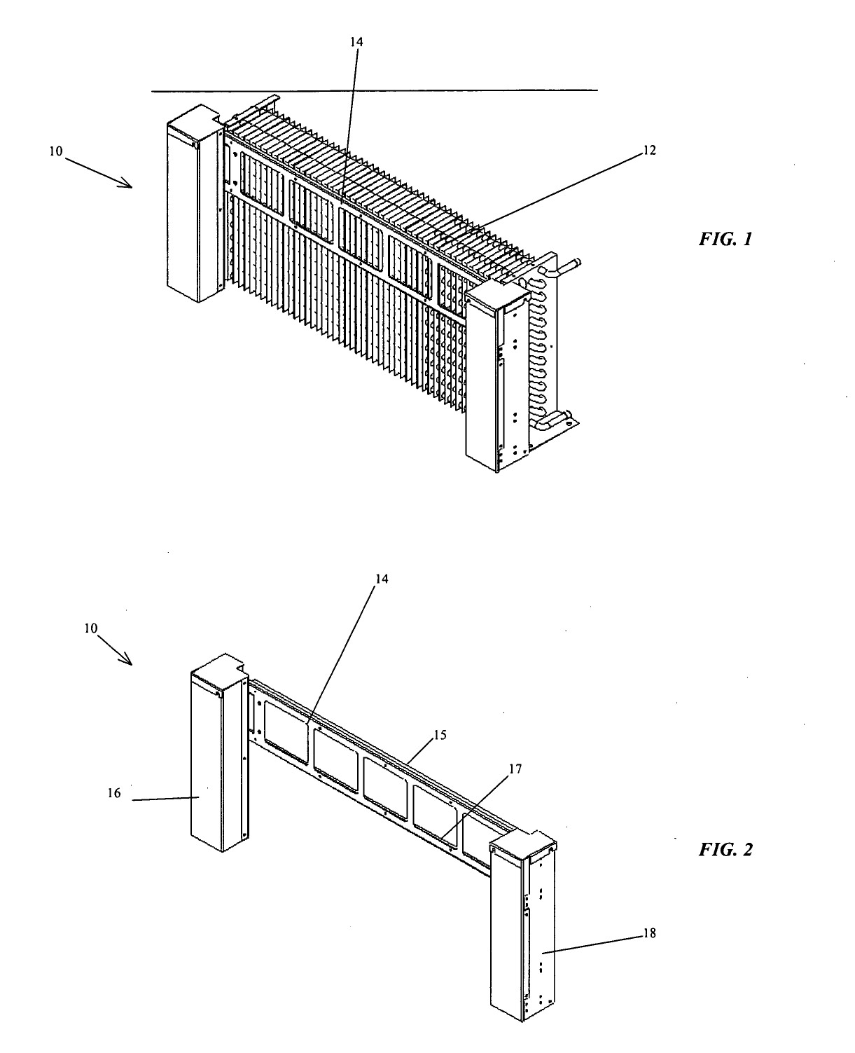

FIG. 1 shows coil cleaner 10 in use with a condenser coil 12. Sweeper assembly 14 translates vertically across condenser coil 12. As sweeper assembly 14 moves across condenser coil 12, sweeper assembly 14 removes dust and debris accumulated on condenser coil 12.

FIG. 2 shows coil cleaner 10. Sweeper assembly 14 is attached to first actuator assembly 18 and second actuator assembly 16. Sweeper assembly 14 includes a first debris removing means 15 and a second debris removing means 17. A debris removing means could be any type of device suitable for removing dust and debris from a surface, such as a brush, sponge, cloth, vacuum or electrostatic dust collector.

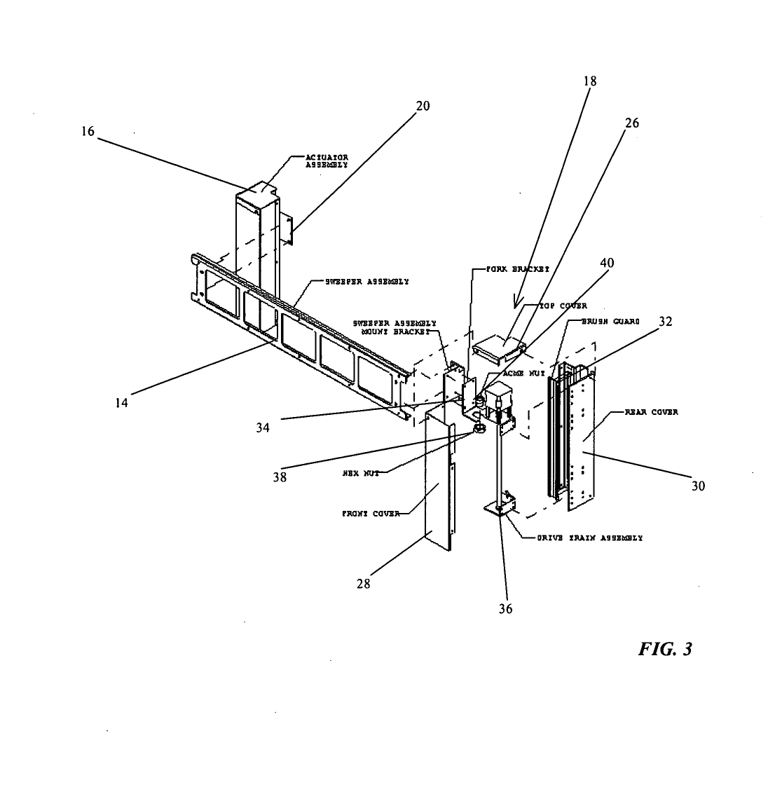

FIG. 3 shows an exploded view of coil cleaner 10. Sweeper assembly 14 is attached to second actuator assembly 16 by way of sweeper assembly mount bracket 20. Similarly, sweeper assembly mount bracket 24 attaches sweeper assembly 14 to second actuator assembly 16.

First actuator assembly 18 and second actuator assembly 16 are mirror images of the other. Second actuator assembly 18 includes top cover 26, front cover 28, and rear cover 30.

Brush guard 32 blocks contaminates from entering the actuator assembly 18.

Fork bracket 34 is attached to first drive train assembly 36 by way of hex nut 38 and lead screw nut 40.

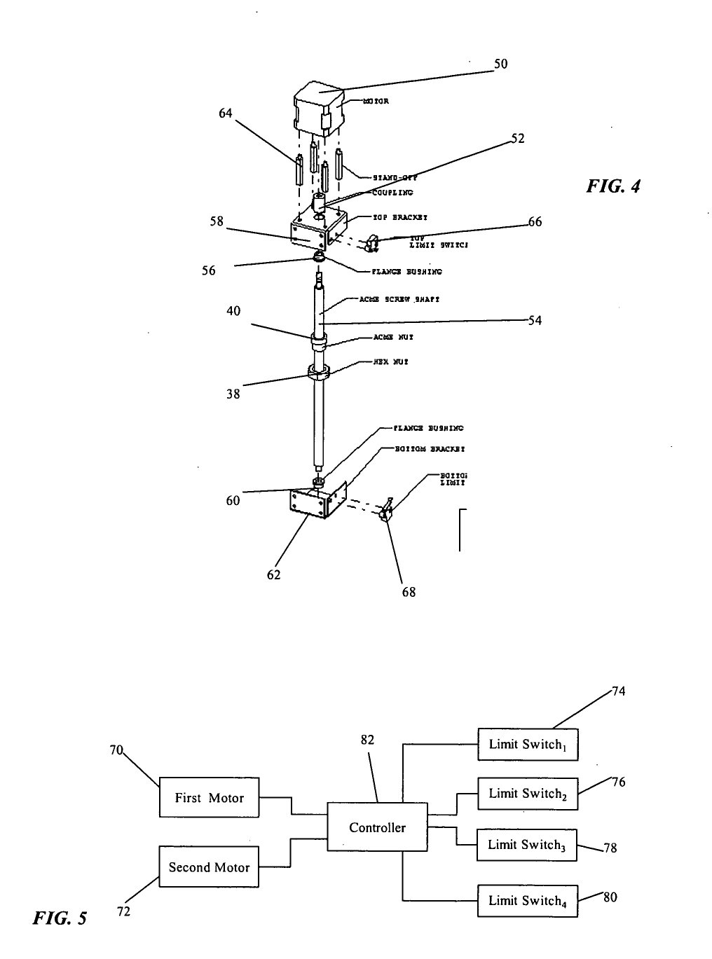

FIG. 4 is an exploded view of first drive train assembly 36. Drive train assembly 36 includes first electric motor 50. First electric motor 50 could be a stepper motor. First electric motor 50 turns rotates lead screw shaft 54 by way of coupling 52. The lead screw could be, for example, an acme screw, a metric acme screw, or a ball screw. First electric motor 50 can rotate lead screw shaft 54 either clockwise or counter clockwise. Lead screw nut 40 translates up and down lead screw shaft 54, thereby moving fork bracket 34. Lead screw nut 40 could be an acme screw nut.

While a motor turning the screw shaft has been proven to be an acceptable method of moving the sweeper assembly, a converse method could be assumed to be directly equivalent. For example, the sweeper assembly could be attached directly to the motor with the motor traversing on a fixed screw shaft.

Top flange bushing 56 fits within top bracket 58, while bottom flange bushing 60 fits within bottom bracket 62. Stand offs 64 separate electric motor 40 from top bracket 58.

Top sensor 66 is attached to top bracket 58, while bottom sensor 68 is attached to bottom bracket 62. Sensors 66, 68 could be either contact or non-contact sensor. For example, limit switches, optical sensors, photoelectric sensors or proximity sensors could be used.

As fork bracket 34 translates up lead screw shaft 54, it eventually activates top sensor 66. Similarly, as fork bracket 34 translates down lead screw shaft 54, it eventually activates bottom sensor 68.

Second actuator assembly 16 includes a drive train assembly similar to that of first drive train assembly 36.

FIG. 5 show a block diagram of the control system for coil cleaner 10. First motor 70 is the motor for first actuator assembly 18 while second motor 72 is the motor for second actuator assembly 16. Sensor₁ 74 is the top sensor for first actuator assembly 18 while sensor₂ 76 is the bottom sensor for first actuator assembly 16. Sensor₃ 78 is the top sensor for second actuator assembly 18, while sensor₄ 80 is the bottom sensor for second actuator assembly 18. All sensors and both motors are connected to controller 82.

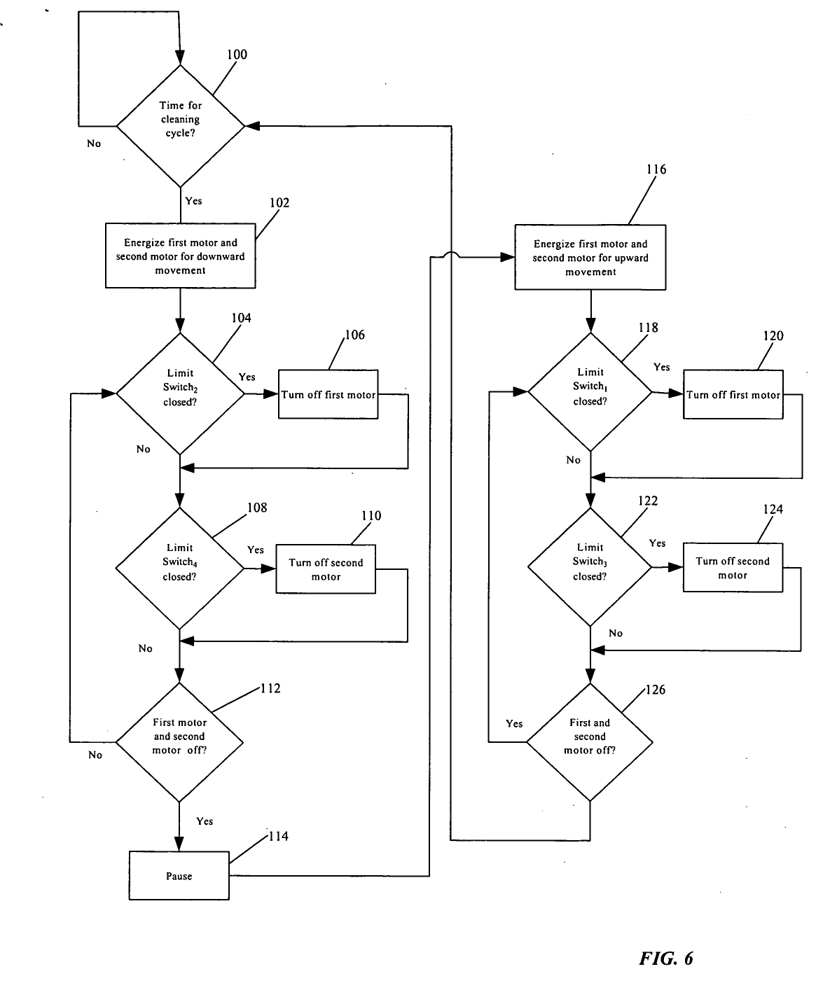

The operation of controller 82 is shown in FIG. 6. Controller 82 is programmed to perform a cleaning cycle at regular intervals, such as once a day. Step 100. If the time for a cleaning cycle has arrived, controller 82 energizes first motor 70 and second motor 72. Step 102. This turns the lead screw shafts for both actuator assemblies, thereby causing the movement of sweeper assembly 14.

Controller 82 then detects whether sensor₂ is closed. Step 104. If so, then first motor 70 is turned off. Step 106. Sensor₄ is then checked by controller 82. Step 108. If it is closed, then second motor 72 is turned off. Step 110. The controller then determines whether both motors are off. Step 112. If so, then the system pauses 114.

Following the pause, both motors are energized so as to raise sweeper assembly 14. Step 116. Sensor₁ 74 is then checked. Step 118. If it is closed, then first motor 70 is turned off. Step 120. Sensor₃ 78 is next checked. Step 122. If it is closed, then second motor 72 is turned off. Step 124. If both first motor 70 and second motor 72 are turned off, then the system again waits for the next cleaning cycle. Step 100.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A coil cleaner for cleaning a condenser coil of a refrigeration system comprising:
a motor;
a screw operationally engaged with the motor;
a sweeper assembly attached to the screw.

2. The coil cleaner of claim 1 further comprising:
a first sensor for disabling motion of the sweeper assembly in a first direction.

3. The coil cleaner of claim 2 further comprising:
a second sensor for disabling motion of the sweeper assembly in a second direction.

4. The coil cleaner of claim 3 where the screw is one of an acme screw, a metric acme screw and a ball screw.

5. The coil cleaner of claim 4 where the sweeper assembly has a first debris removing means and a second debris removing means.

6. A coil cleaner for condenser coils comprising a first actuator assembly and a second actuator assembly, the first actuator assembly and the second actuator assembly operating in concert to move a sweeper assembly across the condenser coils.

7. The coil cleaner of claim 6 where in the first actuator assembly includes a first motor and the second actuator assembly includes a second motor.

8. The coil cleaner of claim 7 further comprising means for moving the sweeper assembly in a first direction and a second direction.

9. The coil cleaner of claim 8 further comprising a first sensor for disabling the movement of the sweeper assembly in the first direction.

10. The coil cleaner of claim 9 further comprising a second sensor for disabling the movement of the sweeper assembly in the second direction.

11. The coil cleaner of claim 10 where the first sensor is coupled to the first motor and the second sensor is coupled to the second motor, and the first sensor is capable of disabling the first motor and the second sensor is capable of disabling the first motor.

12. The coil cleaner of claim 11 further comprising a controller, the controller coupled to the first motor, the first sensor and the second sensor.

13. The coil cleaner of claim 12 further comprising a third sensor and a fourth sensor coupled to the second motor by way of the controller, the third sensor and the fourth sensor capable of disabling the second motor.

14. The coil cleaner of claim 13 where the sweeper assembly includes a first brush and a second brush, the first brush and second brush being spaced apart and generally parallel.

15. The method of claim 14 where the means for moving the sweeper assembly is a screw.

16. The coil cleaner of claim 15 where the first sensor is a limit switch.

17. A method of operating a coil cleaner comprising:
energizing a first motor and a second motor;
moving a sweeper assembly a first distance in a first direction; and
after the sweeper assembly has moved the predetermined distance in a first direction, energizing the first motor and the second motor so as to move the sweeper assembly in a second direction.

18. The method of claim 17 further comprising:
moving the sweeper assembly a second distance in a second direction; and
disabling the first motor and the second motor after the sweeper assembly has moved the second distance.

19. The method of claim 18 further comprising:
detecting whether the sweeper assembly has moved the first distance by detecting whether a first end of the sweeper assembly has moved the first distance and whether a second end of the sweeper assembly has moved the second distance.

20. A coil cleaner comprising:
a sweeper assembly having a first brush and a second brush, the first brush and the second brush being spaced and generally parallel, the sweeper assembly having a first end and a second end;
a first motor coupled to a first screw, the first screw coupled to the first end of the sweeper assembly;
a second motor coupled to a second screw, the second screw coupled to the second end of the sweeper assembly;
a first sensor positioned so as to become closed if the first end is in a first position;
a second sensor positioned so as to become closed if the first end is in a second position;
a third sensor positioned so as to become closed if the second end is in a third position;
a fourth sensor positioned as to become closed if the second end is in a fourth position; and
a controller for energizing the first motor and second motor, the controller coupled to the first sensor, the second sensor, the third sensor, and the fourth sensor, the controller configured so as to disable the first motor when one of the first sensor and the second sensor is closed, and the controller configured so as to disable the second motor when the third sensor or the fourth sensor is closed.

21. A coil cleaner for cleaning a condenser coil of a refrigeration system comprising:
a screw operationally engaged with the motor, the motor moveable on the screw; and
a sweeper assembly attached to the motor.

22. The coil cleaner of claim 21 further comprising:
a first sensor for disabling motion of the sweeper assembly in a first direction.

23. The coil cleaner of claim 22 further comprising:
a second sensor for disabling motion of the sweeper assembly in a second direction.

24. The coil cleaner of claim 23 where the screw is one of an acme screw, a metric acme screw and a ball screw.

25. The coil cleaner of claim 24 where the sweeper assembly has a first debris removing means and a second debris removing means.
